(19) United States
(12) Patent Application Publication
(10) Pub. No.: US 2024/0381318 A1
(43) Pub. Date: Nov. 14, 2024

(54) DEVICES AND METHODS FOR REMAPPING OF PAGING SUBGROUPS

(71) Applicants: Nokia Technologies Oy, Espoo (FI); NOKIA SHANGHAI BELL CO., LTD., Shanghai (CN); NOKIA SOLUTIONS AND NETWORKS OY, ESPOO (FI)

(72) Inventors: Daniela LASELVA, Aalborg (DK); Philippe GODIN, Massy (FR); Chunli WU, Beijing (CN); Jorma Johannes KAIKKONEN, Oulu (FI); Mads LAURIDSEN, Aalborg (DK); Laura Luque SANCHEZ, Aalborg (DK)

(21) Appl. No.: 18/691,995

(22) PCT Filed: Sep. 30, 2021
(86) PCT No.: PCT/CN2021/122224

§ 371 Date: Mar. 14, 2024

(51) Int. Cl. H04W 68/02

(52) U.S. Cl. CPC H04W 68/02

(57) ABSTRACT

Example embodiments generally relate to devices and methods for remapping of paging subgroups. A user equipment (UE) device may be configured to receive from a base station an explicit or implicit indication of remapping between one or more first scheme paging subgroups and one or more L1 paging subgroups, remap a first scheme paging subgroup of the UE device to a L1 paging subgroup based on the received indication of remapping, monitor for a paging early indication (PEI) from the base station including an indication of the remapped L1 paging subgroup, and receive a paging message from the base station based on the PEI.

### TECHNICAL FIELD

Example embodiments described herein generally relate to communication technologies, and more particularly, to devices and methods for remapping of paging subgroups.

### BACKGROUND

Certain abbreviations that may be found in the description and/or in the figures are herewith defined as follows:
AMF Access and Mobility Management Function
CN Core Network
CP Control Plane
CU Centralized Unit
DRX Discontinuous Reception
DU Distributed Unit
gNB next Generation Node-B
NAS Non-Access Stratum
NGAP Next Generation Application Protocol
NR New Radio
PDCCH Physical Downlink Control Channel
PDSCH Physical Downlink Shared Channel
PEI Paging Early Indication
PF Paging Frame
PO Paging Occasion
RAN Radio Access Network
RRC Radio Resource Control
SFN System Frame Number
SSB Synchronization Signal Block
UE User Equipment
WUS Wake Up Signal

In a wireless communication network, user equipment (UE) may transition from a connected state (RRC_CONNECTED) optimized for data transmissions to an idle state (RRC_IDLE) when it may have no data exchange with the network or to an inactive state (RRC_INACTIVE) when it may have infrequent and small data transmissions. In the idle and inactive states, the UE can sleep for most of the time without receiver/transmitter processing, thereby saving battery consumption. To ensure reachability and system information updating, the UE may be configured with a discontinuous reception (DRX) cycle and wake up to monitor paging messages from the network according to the DRX cycle.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a base station is provided. The base station may comprise at least one processor and at least one memory including computer program code. The at least one memory and the computer program code may be configured to, with the at least one processor, cause the base station to perform actions including determining for a cell a first number of Layer 1 (L1) paging subgroups for user equipment (UE) devices supporting a first paging subgrouping scheme and a second number of L1 paging subgroups for UE devices supporting a second paging subgrouping scheme, remapping a third number of first scheme paging subgroups at least to the first number of L1 paging subgroups, the first number being smaller than the third number, and indicating the remapping between the first scheme paging subgroups and the L1 paging subgroups explicitly or implicitly to UE devices served by the base station.

In a second aspect, an example embodiment of a user equipment (UE) device is provided. The UE device may comprise at least one processor and at least one memory including computer program code. The at least one memory and the computer program code may be configured to, with the at least one processor, cause the UE device to perform actions including receiving from a base station an explicit or implicit indication of remapping between one or more first scheme paging subgroups and one or more L1 paging subgroups, remapping a first scheme paging subgroup of the UE device to a L1 paging subgroup based on the received indication of remapping, monitoring for a paging early indication (PEI) from the base station including an indication of the remapped L1 paging subgroup, and receiving a paging message from the base station based on the PEI.

In a second aspect, an example embodiment of a user equipment (UE) device is provided. The UE device may comprise at least one processor and at least one memory including computer program code. The at least one memory and the computer program code may be configured to, with the at least one processor, cause the UE device to perform actions including receiving from a base station an indication of remapping between one or more second scheme paging subgroups and one or more L1 paging subgroups, remapping a second scheme paging subgroup of the UE device to a L1 paging subgroup based on the received indication of remapping, monitoring for a paging early indication (PEI) from the base station including an indication of the remapped L1 paging subgroup, and receiving a paging message from the base station based on the PEI.

In a third aspect, an example embodiment of a network function device is provided. The network function device may comprise at least one processor and at least one memory including computer program code. The at least one memory and the computer program code may be configured to, with the at least one processor, cause the network function device to perform actions including providing to a base station at least one of (i) statistics information of user equipment (UE) devices supporting a first paging subgrouping scheme and/or UE devices supporting a second paging subgrouping scheme or (ii) first scheme paging subgroup information comprising at least one of an estimated number of UE devices per first scheme paging subgroup and/or an average paging probability per first scheme paging subgroup, and transmitting a paging notification for a UE device to the base station. The paging notification may include an indication of UE capability to support paging subgrouping.

Example embodiments of methods, apparatus and computer program products supporting the remapping of the paging subgroups are also provided. Such example embodiments generally correspond to the above example embodiments of the network device, the terminal device and the network function device and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a communication system in which one or more example embodiments of the present disclosure may be implemented.

FIGS. 2A, 2B and 2C are schematic diagrams illustrating some examples of monitoring a paging occasion.

FIGS. 3A and 3B are schematic diagrams illustrating some examples of a Layer 1 (L1) paging subgroup indication.

FIG. 4 is a message flow chart illustrating operations for paging user equipment (UE) devices with capabilities of supporting network assignment based paging subgrouping or UE identity (UE-ID) based paging subgrouping in accordance with some example embodiments.

FIGS. 5A and 5B are schematic diagrams illustrating examples of L1 paging subgroups used for the network assignment based paging subgrouping and the UE-ID based paging subgrouping in accordance with some example embodiments.

FIGS. 6A, 6B, 6C, 6D and 6E are schematic diagrams illustrating examples of remapping the network assigned paging subgroups to the L1 paging subgroups in accordance with some example embodiments.

FIG. 7 is a schematic diagram illustrating an example of a L1 paging subgroup indication including a bitmap in accordance with an example embodiment.

FIG. 8 is a schematic functional block diagram illustrating an apparatus implemented at a base station in accordance with an example embodiment.

FIG. 9 is a schematic functional block diagram illustrating an apparatus implemented at a user equipment device in accordance with an example embodiment.

FIG. 10 is a schematic functional block diagram illustrating an apparatus implemented at a user equipment device in accordance with another example embodiment.

FIG. 11 is a schematic functional block diagram illustrating an apparatus implemented at a network function device in a core network in accordance with an example embodiment.

FIG. 12 is a schematic structural block diagram illustrating a communication system in which example embodiments of the present disclosure may be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a centralized unit (CU), one or more distributed units (DUs), one or more remote radio heads (RRHs) or remote radio units (RRUs). The number and functions of these distributed units depend on the selected split RAN architecture.

As used herein, the term “network function (NF)” refers to a processing function in a network such as a core network, which defines functional behaviors and relating interfaces. The network function may be implemented by using dedicated hardware, or may be implemented by running software on dedicated hardware, or may be implemented on a form of a virtual function on a common hardware platform. From a perspective of implementation, network functions may be classified into a physical network function and a virtual network function. From a perspective of use, network functions may be classified into a dedicated network function and a shared network function.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

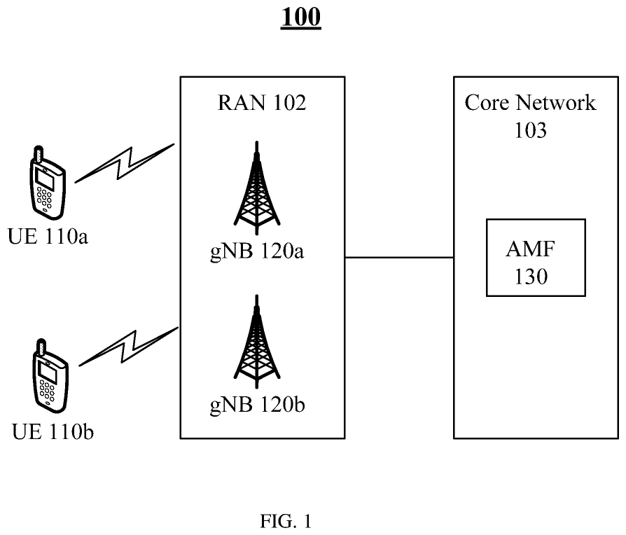

FIG. 1 illustrates a communication system 100 in which example embodiments of the present disclosure may be implemented. The communication system 100 may be a multiple access system capable of supporting communication with multiple users sharing available system resources. The communication system 100 may employ one or more channel access schemes such as Time Division Multiple Access (TDMA), Code Division Multiple Access (CDMA), Time Division Synchronous Code Division Multiple Access (TD-SCDMA), Frequency Division Multiple Access (FDMA), Orthogonal Frequency Division Multiple Access (OFDMA), Single Carrier Frequency Division Multiple Access (SC-FDMA) and the like. These multiple access schemes may be formulated in 4G Long Term Evolution (LTE), 5G New Radio (NR), or beyond 5G radio standards. For convenience of description, FIG. 1 shows the communication system 100 as a 5G NR system, but it would be appreciated that example embodiments disclosed herein can also be implemented in a 4G LTE system or a future communication system.

Referring to FIG. 1, the communication system 100 may include base stations 120a and 120b, which are shown as gNBs and form at least a part of a radio access network (RAN) 102. The base stations 120a, 120b each may be configured to transmit and receive wireless signals in one or more frequency bands or bandwidth parts (BWPs), providing service coverage for one or more cells. The cells may include macro cells, and small cells such as femtocells, picocells and microcells. UEs 110a, 110b may camp in one or more cells and connect with one or more of the base stations 120a, 120b over an air interface, communicating with the base stations 120a, 120b on uplink and downlink channels. While two base stations and two UEs are depicted in FIG. 1, it would be appreciated that the communication system 100 may include any number of base stations providing services for any number of UEs.

The communication system 100 may also include a core network (CN) 103, which may include a plurality of network functions. FIG. 1 shows an Access and Mobility Management Function (AMF) 130 in the core network 103. The AMF 130 may operate as a control node to provide control plane (CP) services such as registration management, connection management, mobility management, security context management, access authentication and authorization, and the like.

The UE 110 may initially connect to the base station 120 via a random access procedure. When an RRC connection is successfully established between the UE 110 and the base station 120, the UE 110 can receive services from the network by receiving and transmitting data traffic on downlink and uplink channels. When there is no or little data exchange between the UE 110 and the network, the UE 110 may transition to an idle or inactive state for power saving. If the network has incoming downlink data for the UE 110, the core network 103 or the base station 120 may page the UE 110 to establish or resume the RRC connection. As such, the UE 110 has to keep monitoring the paging message to ensure reachability.

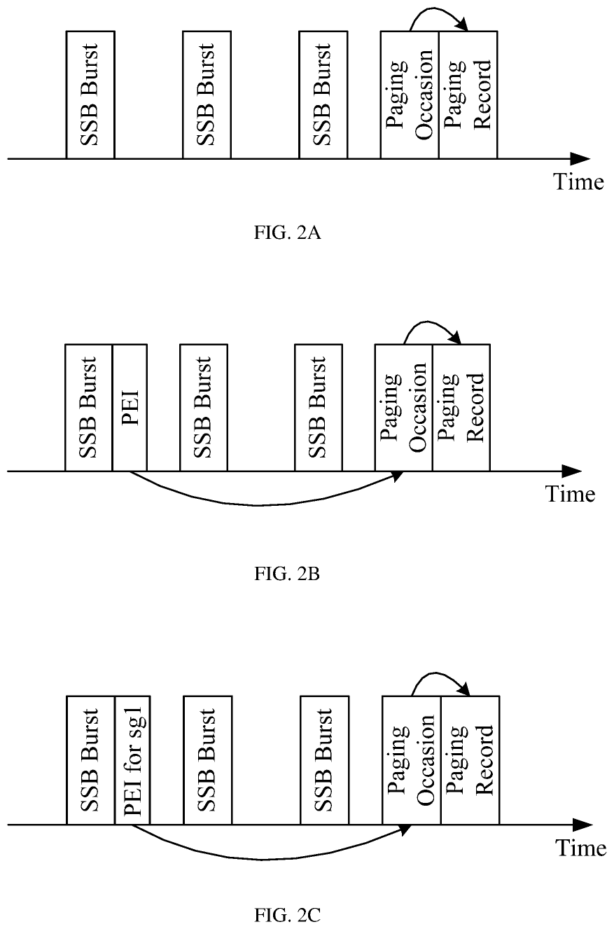

It is also important to reduce power consumption for monitoring the paging message at the UE. FIGS. 2A-2C show some examples of monitoring the paging message. Referring to FIG. 2A, the UE usually needs to receive 1-3 Synchronization Signal Block (SSB) bursts prior to a paging occasion (PO) to obtain sufficient time and frequency synchronization with the network so that it can decode the paging record if present. The exact number of SSB bursts that should be received to obtain adequate synchronization depends on the radio conditions and implementation of the given UE modem. For simplicity the description assumes that SSBs are used for synchronization, however in general other reference signals, such as tracking reference signal (TRS) and CSI-RS, can also be used to obtain synchronization in combination with or alternatively to SSBs. Thus, generally, the exact amount of reference signals needed to obtain synchronization will depend on the above-mentioned factors. If the synchronization is not good enough, the decoding of a paging record based on the paging occasion may fail. The paging occasion can be defined by a set of PDCCH monitoring occasions where downlink control information (DCI) for paging (paging DCI) can be sent, and the paging DCI indicates the PDSCH resources allocation for the paging message which carries the paging record(s). If the UE is not paged in the paging occasion, it will have wasted energy receiving the SSB burst(s) for obtained synchronization.

FIG. 2B shows another example where a paging early indication (PEI) may be sent from the network to one or more UEs prior to the paging occasion. The PEI works as a wake up signal (WUS) to indicate whether the UE can expect to be paged in the paging occasion. Based on the indication the UE can therefore also determine whether it needs to receive the (additional) SSB bursts or not.

FIG. 2C shows another example where paging subgrouping is applied to reduce the so-called false paging alarms. In the regular paging mechanism, the UE utilizes its UE identity (UE ID) to determine the system frame number (SFN) of the paging frame (PF) and the index of the paging occasion (PO) within the paging frame where to monitor for paging messages. A plurality of UEs may share the same paging occasion and read the same paging DCI that is targeted to the same P-RNTI (paging-RNTI). Therefore, the plurality of UEs would monitor the paging occasion and decode the paging record, despite that there is only one UE targeted by the paging, which will find its UE ID in the paging record. The remaining UEs, who do not find their UE IDs in the paging record, have thus wasted energy in receiving and decoding the paging message unnecessarily. This is denoted as false paging alarm. To address this issue, the network can apply paging subgrouping to split the UEs sharing the same paging occasion into subgroups, and the PEI can also indicate which subgroup(s) are paged. It will effectively reduce the false alarm rate for the UEs assigned to subgroups that are not paged. As illustrated in FIG. 2C, the PEI including an indication of subgroup #1 indicates that UEs in the subgroup #1 will expect to be paged, and UEs in other subgroups do not need to monitor the paging occasion and decode the paging record, therefore further reducing the power consumption of the UEs.

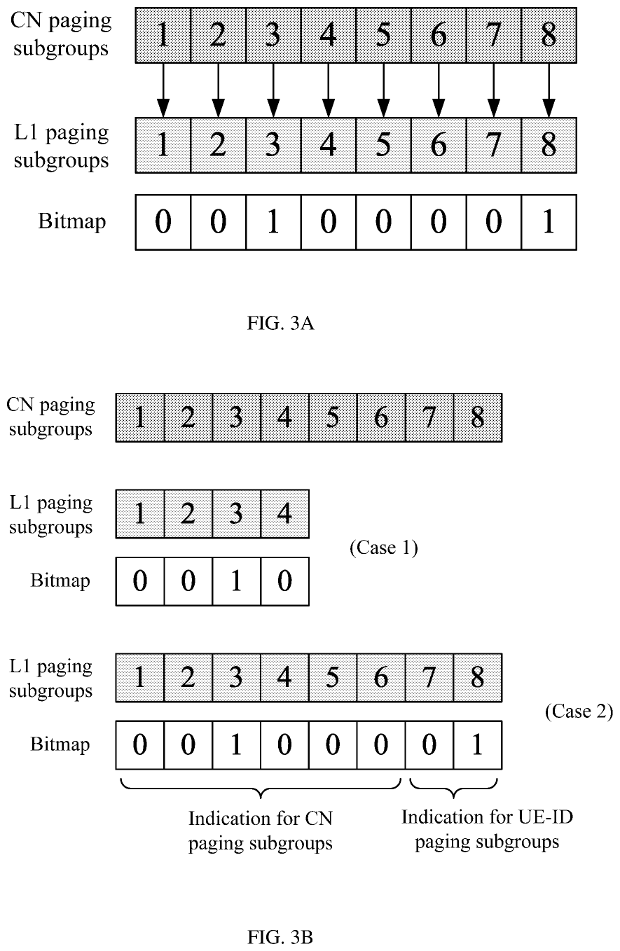

The network may configure paging subgrouping for the UEs. For example, the AMF 130 in the core network (CN) 103 may assign a UE with a CN paging subgroup (CN subgroup identifier), where the same CN subgroups may be used in the registration area managed by the AMF 130. Since the CN paging subgroups should be applicable to the entire registration area and associated tracking areas, then the granularity (number) of the CN paging subgroups should be large enough to allow sufficient separation of UEs with distinctive characteristics. This will in turn minimize the false paging alarms. When the UE is to be paged, the base station would transmit a PEI with a Layer 1 (L1) paging subgroup indication to UEs camped in the cells served by the base station, and the L1 paging subgroup indication would indicate the CN paging subgroup ID of the UE to be paged. For example, referring to FIG. 3A, when there are 8 CN paging subgroups to be indicated in L1 (the physical layer), the L1 paging subgroup indication may be designed as a bitmap having a size equal to the number of the CN paging subgroups so that the CN paging subgroups can be used as they are in the L1 paging subgroup indication. For example, if a first UE is assigned with a CN paging subgroup #3 and a second UE is assigned with a CN paging subgroup #8, the bits #3 and #8 in the bitmap may be set to “true” while remaining bits may be set to “false”. The PEI including the bitmap would indicate that UEs in the CN paging subgroups #3 and #8 are to be paged.

In some cases, however, the L1 paging subgroup indication may not be large enough to accommodate all the CN paging subgroup IDs. In a first case, for example, a cell may operate with more than one paging occasion per paging frame as the paging load increases. In such a case, a single PEI should be able to indicate the subgrouping information for all paging occasions in the paging frame. For example, if there are two paging occasions per paging frame, the L1 paging subgroup indication (e.g., 8 bits) has to be split into two parts such that the first part (e.g., the first 4 bits) is used to indicate the CN paging subgroups corresponding to the first paging occasion and the second part (e.g., the last 4 bits) is used to indicate the CN paging subgroups corresponding to the second paging occasion. As a result, the L1 subgroup indication would have a size of 4 bits per paging occasion, as shown in FIG. 3B, and thus it would be smaller than the number of the CN paging subgroups. As the paging load may differ across cells, a cell needs to set the L1 subgroup indication field size based on its own needs.

In a second case, some UEs do not support the CN assignment based paging subgrouping but support only the UE-ID based paging subgrouping. Then the L1 paging subgroup indication would use a part for indicating the UE-ID based paging subgroups, in addition to a part for indicating the CN assigned paging subgroups, as shown in FIG. 3B. As a result, the L1 subgroup indication, or the part of the L1 subgroup indication for UEs supporting the CN assignment based paging subgrouping, has a size smaller than the size of the CN assigned paging subgroups. The CN assigned paging subgroups cannot be used “as they are” in the L1 subgroup indication.

Therefore, there is a need to remap the network assigned paging subgroups to the L1 paging subgroup indication. Hereinafter, example embodiments are described to provide a simple, robust and flexible way to remap the network assigned paging subgroups to the L1 paging subgroups. It would be appreciated that the example embodiments described herein may also be applied to remap other paging subgroups to the L1 paging subgroups to reduce UE power consumption for monitoring the paging messages.

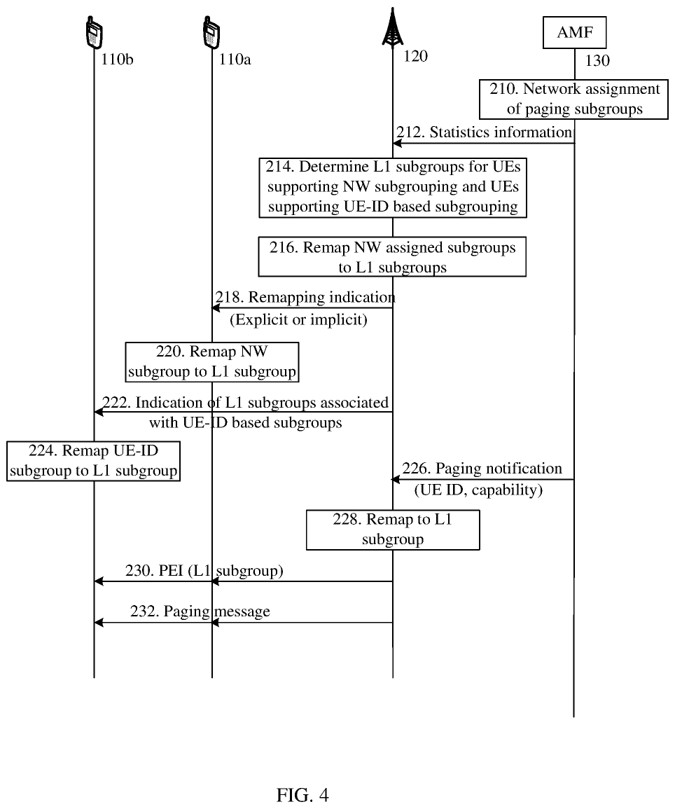

FIG. 4 is a message flow chart illustrating operations for paging user equipment (UE) devices with capabilities of supporting network assignment based paging subgrouping or UE identity (UE-ID) based paging subgrouping in accordance with some example embodiments. The operations shown in FIG. 4 may be performed by a core network, a base station and UEs, for example the AMF 130 in the core network 103, the base stations 120, and the UEs 110 described above with reference to FIG. 1. In some example embodiments, the UEs 110, the base stations 120 and the AMF 130 may include a plurality of means, modules or elements for performing the operations discussed below with reference to FIG. 4, and the means, modules and elements may be implemented in various manners including for example software, hardware, firmware or any combination thereof to perform the operations. For convenience of description, FIG. 4 shows the UE 110a and the UE 110b. It is assumed that the UE 110a supports at least the network assignment based paging subgrouping, and the UE 110b supports only the UE-ID based paging subgrouping.

Referring to FIG. 4, at an operation 210, the AMF 130 may assign paging subgroups for UEs which have capabilities to support a network assignment based paging subgrouping. In some example embodiments, a UE may indicate its capabilities in a registration request sent to the AMF 130. When the AMF 130 determines from the UE capabilities that the UE can support a network assignment based paging subgrouping, the AMF 130 can assign a paging subgroup for the UE based on e.g., UE paging probability, a number of UEs in a subgroup and/or other local information. For example, the lower the UE paging probability the lower the value of the paging subgroup ID assigned to the UE, and vice-versa. The AMF 130 may indicate the assigned paging subgroup ID in a registration accept message to the UE (not shown in the figure). The AMF 130 may also indicate the assigned paging subgroup ID for the UE in a UE context modification request to the base station 120 serving the UE. The network assigned paging subgroups can be used in the registration area associated with the AMF 130.

In some example embodiment, the number of the network assigned paging subgroups may be predefined or pre-configured to a fixed value, e.g., 8, 12, 16. In some other example embodiments, the number of the network assigned paging subgroups may be determined by the AMF 130 taking into account of a maximum number of L1 paging subgroups (L1 subgrouping field size) and statistics information of UEs camping in the registration area e.g. in respect to their subgrouping capability. Given the maximum number of L1 paging subgroups, the AMF 130 may determine the number of network assigned paging subgroups in proportion to a percentage of UEs supporting the network assignment based paging subgrouping in an aggregation of UEs supporting paging subgrouping. For example, the AMF 130 may determine the number of the network assigned paging subgroups as an integer obtained by multiplying a fixed value and the percentage of UEs supporting the network assignment based paging subgrouping, as shown by any one of Equations 1 and 2. In the Equations 1 and 2, N_{sg-nw} denotes the number of the network assigned paging subgroups, N_{sg-L1} is the maximum number of L1 paging subgroups, N_{UE-nw} is a number of UEs supporting the network assignment based paging subgrouping, N_{UE-ID} is a number of UEs supporting the UE-ID based paging subgrouping, ceiling( ) is a round-up function, and floor( ) is a round-down function.

$${N}_{s g - n w} = ceiling ( {N}_{s g - L 1} * {N}_{U E - n w} / ( {N}_{U E - n w} + {N}_{U E - I D} ) ) \qquad Equation 1$$

$${N}_{s g - n w} = floor ( {N}_{s g - L 1} * {N}_{U E - n w} / ( {N}_{U E - n w} + {N}_{U E - I D} ) ) \qquad Equation 2$$

In an operation 212, the AMF 130 may provide statistics information for remapping the network assigned paging subgroups to the L1 paging subgroups to the base station 120. The AMF 130 has statistical knowledge of a pool of UEs supporting the network assignment based paging subgrouping (referred to as the CN pool hereinafter) and a pool of UEs supporting the UE-ID based paging subgrouping (referred to as the UE-ID pool hereinafter) present in a cell, a tracking area or a registration area. In the operation 212, the AMF 130 may provide a size of the CN pool and/or a size of the UE-ID pool to the base station 120. For example, the AMF 130 may provide a percentage of UEs supporting the network assignment based paging subgrouping and/or a percentage of UEs supporting the UE-ID based paging subgrouping in an aggregation of the UEs supporting paging subgrouping to the base station 120.

Additionally or alternatively, the AMF 130 may also provide statistics information of the network assigned paging subgroups to the base station 120. For example, the statistics information of the network assigned paging subgroups may include an estimated number of UEs per network assigned paging subgroup and/or an average paging probability per network assigned paging subgroup.

The AMF 130 may transmit the statistics information to the base station 120 over no-UE associated NGAP signaling. In some example embodiments, at least a portion of the statistics information may be available at the base station 120 or received from another base station. For example, the base station 120 may maintain statistics information in one or more cells served by the base station, or receive the statistics information from one or more neighboring base stations. In some example embodiments, the statistics information may be configured by an operator to the base station 120 through a RAN operation and maintenance (RAN O&M) system.

At an operation 214, the base station 120 may determine for a cell a first number of L1 paging subgroups for UEs supporting the network assignment based paging subgrouping and a second number of L1 paging subgroups for UEs supporting the UE-ID based paging subgrouping. It would be appreciated that the network assignment based paging subgrouping and the UE-ID based paging subgrouping are described here as examples for paging subgrouping, and the example embodiments may also be implemented with other paging subgrouping solutions. For example, the base station 120 may determine three or more pools of the L1 paging subgroups for three or more paging subgrouping solutions.

The base station 120 may determine the numbers of L1 paging subgroups for the network assigned subgroups and the UE-ID based subgroups based on the statistics information of the UEs supporting the network assignment based subgrouping and the UEs supporting the UE-ID based subgrouping. Given a total number N_{sg-L1-po} of available L1 paging subgroups, the base station 120 may determine the first number of L1 subgroups for the network assigned subgroups in proportion to the percentage of the UEs supporting the network assignment based subgrouping in the aggregation of UEs supporting paging subgrouping.

The total number N_{sg-L1-po} of available L1 paging subgroups may be determined at the base station 120 in consideration of the maximum number N_{sg-L1} of L1 paging subgroups and a number Nₚₒ of paging occasions per paging frame. For example, the total number N_{sg-L1-po} of available L1 paging subgroups may be determined as the maximum number N_{sg-L1} of L1 paging subgroups divided by the number Nₚₒ of paging occasions per paging frame, i.e., N_{sg-L1-po}=N_{sg-L1}/Nₚₒ. The base station 120 may determine the first number N_{sg-L1-nw} of L1 paging subgroups for the network assigned subgroups according to any one of Equations 3 and 4. Then the second number N_{sg-L1-ID} of L1 paging subgroups for the UE-ID based subgroups may be determined according to Equation 5.

$${N}_{s g - L 1 - n w} = ceiling ( {N}_{sg - L 1 - po} * {N}_{U E - n w} / ( {N}_{U E - n w} + {N}_{U E - I D} ) ) \qquad Equation 3$$

$${N}_{s g - L 1 - n w} = floor ( {N}_{sg - L 1 - po} * {N}_{U E - n w} / ( {N}_{U E - n w} + {N}_{U E - I D} ) ) \qquad Equation 4$$

$${N}_{s g - L 1 - I D} = {N}_{s g - L 1 - p o} - {N}_{s g - L 1 - n w} \qquad Equation 5$$

For example, if the total number N_{sg-L1-po} of the available L1 paging subgroups is 8, and the CN pool has a size of 75% of all the UEs that support paging subgrouping, then the base station 120 may decide that 6 L1 subgroups may be used for the network assignment based subgrouping and remaining 2 L1 subgroups may be used for the UE-ID based subgrouping, as shown in FIG. 3B. If the total number N_{sg-L1-po} of the available L1 paging subgroups is 4, then 3 L1 subgroups may be used for the network assignment based subgrouping and 1 L1 subgroup may be used for the UE-ID based subgrouping.

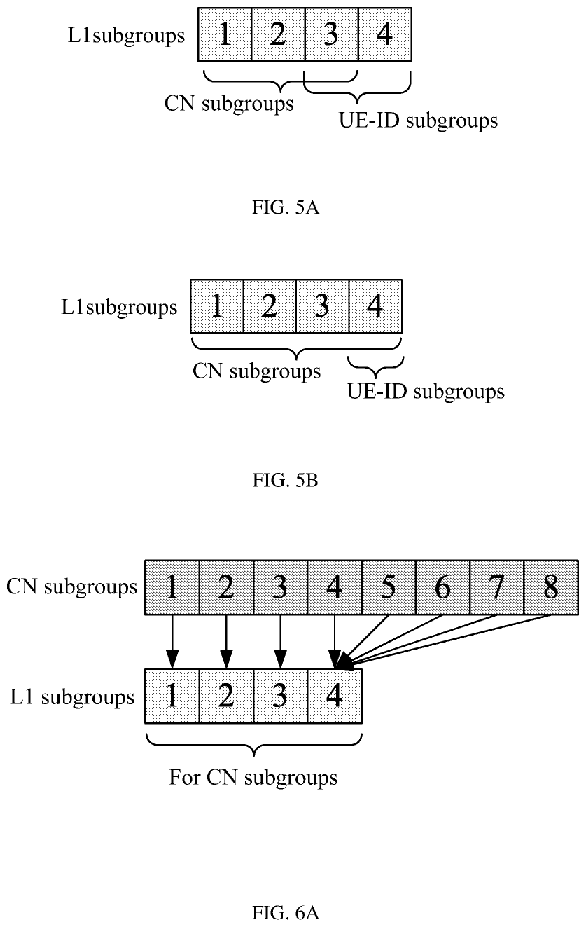

In the above example embodiments, the L1 subgroups for the network assignment based subgrouping are separated from the L1 subgroups for the UE-ID based subgrouping. It would be beneficial from the view point of reducing false paging alarms. In some example embodiments, if the total number of the available L1 paging subgroups is small because for example there are more than one paging occasion in the paging frame, then one or more of the L1 subgroups for the network assignment based subgrouping may overlap with one or more of the L1 subgroups for the UE-ID based subgrouping. For example, referring to FIG. 5A, when the total number of the available L1 paging subgroups is 4, the base station 120 may determine that the L1 paging subgroups #1-#3 are used for the network assignment based subgrouping and the L1 paging subgroups #3-#4 are used for the UE-ID based subgrouping, as shown in FIG. 5A. In this case, the L1 paging subgroup #3 is used for both the network assignment based subgrouping and the UE-ID based subgrouping. As another example, the base station 120 may determine that the L1 paging subgroups #1-#4 are all used for the network assignment based subgrouping, only the last L1 subgroup #4 or no L1 subgroup is used for the UE-ID based subgrouping, as shown in FIG. 5B. When there is no L1 subgroup used for the UE-ID based subgrouping, the UEs supporting only the UE-ID based subgrouping may be paged in a legacy way.

At an operation 216, the base station 120 may remap the network assigned paging subgroups at least to the first number of L1 paging subgroups determined at the operation 214 for the network assignment based paging subgrouping, when a third number of the network assigned paging subgroups is larger than the first number. In some example embodiments, the network assigned paging subgroups may be remapped to the L1 subgroups for network subgrouping according to predefined or standardized remapping rules. For example, the remapping rules may be formulated in 3GPP standard specifications and predefined in the base stations 120 and the UEs 110. In some example embodiments, the remapping rules may also be predefined in the AMF 130. Given the remapping rules, the AMF 130 would make the subgroup assignment appropriately in the tracking area to ensure homogenous paging subgroups before and after the remapping of the network assigned subgroups to the L1 subgroups.

In some other example embodiments, the remapping rules may be determined by the base station 120. It would allow a fully flexible remapping of the network assigned subgroups to the L1 subgroups. The base station 120 may determine the remapping rules based on information of the network assigned paging subgroups received from the AMF 130, such as the estimated number of UEs per network assigned paging subgroup and/or the average paging probability per network assigned subgroup received over the no-UE associated NGAP signaling in the operation 212. For example, based on the network assigned subgroup information, the base station 120 can determine an optimal strategy to merge two or more network assigned subgroups so that the combined average paging probability would not violate a network defined threshold. In turn, this would bound the false alarm probability associated to the merged subgroups.

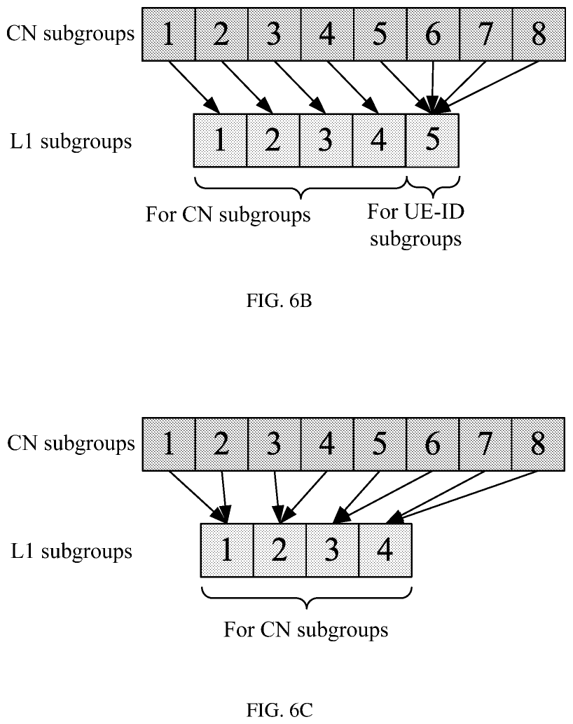

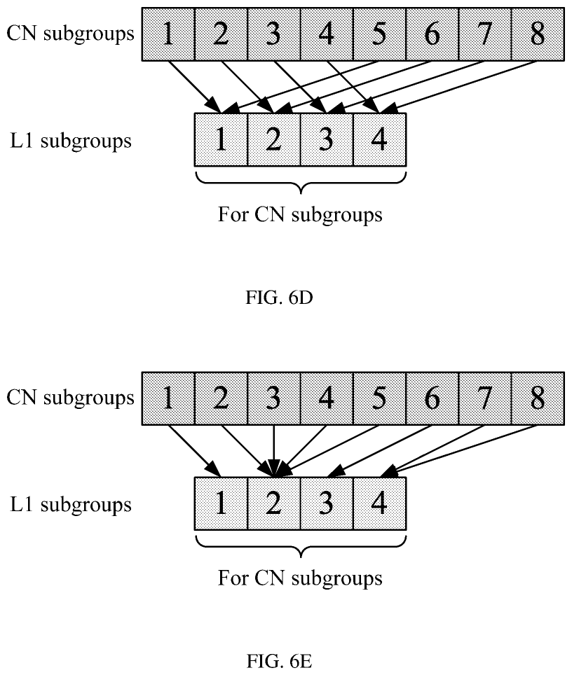

Various remapping rules may be used in the operation 216, either predefined/standardized for the base station 120 or flexibly determined at the base station 120. FIGS. 6A, 6B, 6C, 6D and 6E are schematic diagrams illustrating some examples of remapping the network assigned paging subgroups to the L1 paging subgroups in accordance with some example embodiments. Referring to FIG. 6A, the network assigned subgroups exceeding the number of the L1 subgroups assigned to the network assigned subgroups may be remapped to the last one of the L1 subgroups for the network assigned subgroups. For example, when there are 8 network assigned subgroups and 4 L1 subgroups used for the network assigned subgroups, the network assigned subgroups #1-#4 may be remapped to the L1 subgroups #1-#4, respectively, and the remaining network assigned subgroups #5-#8 may be remapped to the last L1 subgroup #4.

In an example shown in FIG. 6B, the network assigned subgroups exceeding the number of the L1 subgroups assigned to the network assigned subgroups may be remapped to the last L1 subgroup, no matter if the last L1 subgroup is used for the network assigned subgroups or the UE-ID based subgroups. For example, there are 8 network assigned subgroups and 5 L1 subgroups. the L1 subgroups #1-#4 are assigned to the network assigned subgroups and the last L1 subgroup #5 is assigned to the UE-ID based subgroups. In the example shown in FIG. 6B, the network assigned subgroups #1-#4 may be remapped to the L1 subgroups #1-#4, respectively, and the remaining network assigned subgroups #5-#8 may be remapped to the last L1 subgroup #5 which is also used for the UE-ID based subgroups. In this case, the network assigned subgroups #5-#8 share the L1 subgroup assigned to the UE-ID based subgroups.

In an example shown in FIG. 6C, the network assigned subgroups may be evenly remapped to the L1 subgroups assigned to the network assigned subgroups. For example, when there are 8 network assigned subgroups and 4 L1 subgroups assigned to the network assigned subgroups, every two network assigned subgroups may be remapped to one L1 subgroup.

FIG. 6D shows an example where the network assigned subgroups may be remapped in a Round-Robin way to the L1 subgroups assigned to the network assigned subgroups. For example, the network assigned subgroups #1-#4 may be remapped to the L1 subgroups #1-#4, respectively. Then the subsequent network assigned subgroups #4-#8 may be remapped to the L1 subgroups #1-#4 in an ascending order or to the L1 subgroups #4-#1 in a descending order, respectively. When the network assigned subgroups with lower indices have lower paging probabilities, the ascending or descending order may be selected so that subgroups with lower paging probabilities will be less likely to be merged with other groups.

The remapping rules shown in FIGS. 6A-6D may be predefined/standardized in the base station 120. FIG. 6E shows a flexible approach for remapping the network assigned subgroups to the L1 subgroups, which may be determined at the base station 120 based on information acquired from the core network 103 for example the AMF 130. In the example, The network assigned subgroup #1 is remapped to the L1 subgroup #1, the network assigned subgroup #2-#5 are remapped to the L1 subgroup #2, the network assigned subgroup #6 is remapped to the L1 subgroup #3, and the network assigned subgroup #7-#8 are remapped to the L1 subgroup #4.

In some example embodiments, one or more of the L1 paging subgroups may be reserved for one or more of the network assigned paging subgroups, respectively. For example, the L1 paging subgroups #1-#2 may be reserved, and only the network assigned subgroups #1-#2 may be remapped to the reserved L1 paging subgroups #1-#2, respectively. This can ensure isolation of the network assigned subgroups #1-#2 and prevent them from being merged with other subgroups. The reserved L1 paging subgroup(s) may be used in combination with any one of the above example embodiments shown in FIGS. 6A-6E.

In some example embodiments, the base station 120 may also remap the UE-ID based paging subgroups to the L1 paging subgroups at the operation 216. If the number of the UE-ID based paging subgroups is equal to the number of the L1 paging subgroups assigned to the UE-ID based paging subgrouping at the operation 214, the UE-ID based paging subgroups may be used as they are in the L1 paging subgroups assigned to the UE-ID based paging subgrouping. If the number of the UE-ID based paging subgroups is larger than the number of the L1 paging subgroups assigned to the UE-ID based paging subgrouping, the UE-ID based paging subgroups may be remapped the L1 paging subgroups assigned to the UE-ID based paging subgrouping in a way similar to the network assigned subgroups, and a repetitive description will be omitted here.

Referring back to FIG. 4, at an operation 218, the base station 120 may indicate the remapping between the network assigned paging subgroups and the L1 paging subgroups explicitly or implicitly to UEs served by the base station 120, for example to the UE 110a. It is assumed that the UE 110a has capabilities of supporting the network assignment based paging subgrouping, and it has received a network assigned paging subgroup ID determined by the AMF 130 in the operation 210. In some example embodiments, the base station 120 may provide an explicit indication of the remapping to the UE 110a. For example, the explicit indication of remapping may include an explicit association of one or more network assigned paging subgroups to one or more L1 paging subgroups. In some example embodiments, the explicit association may include all of the network assigned paging subgroup IDs remapped to the L1 paging subgroup IDs. In some example embodiments, the explicit association may include the location (e.g. bit) in the L1 paging subgroup indication field to which a network assigned paging subgroup ID is remapped. The base station 120 may broadcast the explicit association to the UEs served by the base station 120. In some example embodiments, one or more of the network assigned paging subgroup IDs may be absent in the explicit association, and the UE 110a would understand that the absent network assigned paging subgroup IDs would be remapped to the corresponding L1 subgroup IDs. For example, if the network assigned paging subgroup #2 is not included in the remapping indication, the UE 110a would understand that the network assigned paging subgroup #2 is remapped to the L1 subgroup #2. In some example embodiments, the explicit association may include only the network assigned subgroup ID of the UE 110a remapped to a L1 subgroup, and the base station 120 may send the remapping indication to UEs separately.

In some example embodiments, when the remapping between the network assigned paging subgroups and the L1 paging subgroups is determined at the base station according to predefined/standardized remapping rules that are also known to the UE 110a, the base station 120 may provide the remapping indication implicitly to the UE 110a. For example, the base station 120 may provide subgrouping information for remapping to the UE 110a and then the UE 110a may derive the remapping between at least the network assigned subgroup of the UE 110a and a L1 subgroup from the subgrouping information. For example, the subgrouping information may include information about cell support to network assignment based subgrouping or UE-ID based paging subgrouping, a number of L1 paging subgroups assigned to the network assigned subgroups or the UE-ID based paging subgroups, and/or a total number of available L1 subgroups (size of the L1 subgroup indication field used in the cell).

Based on the received or derived remapping indication, the UE 110a may remap its network assigned subgroup to the L1 subgroup at an operation 220. Then the UE 110a can monitor for a paging early indication (PEI) including an indication of the remapped L1 paging subgroup from the base station 120.

In some example embodiments, the base station 120 may indicate an association of one or more L1 subgroups with one or more UE-ID based paging subgroups to UEs supporting the UE-ID based subgrouping, for example the UE 110b, at an operation 222. The UE 110b may determine its UE-ID based paging subgroup ID based on the UE ID thereof or receive the UE-ID based paging subgroup ID from the base station 120. Then at an operation 224, the UE 110b may remap its UE-ID based paging subgroup ID to the L1 paging subgroup based on the association indication received at the operation 222.

Although it is described here that the base station 120 sends the remapping indication for the network assigned subgroups to the UE 110a supporting the network assignment based subgrouping and sends the remapping indication for the UE-ID based subgroups to the UE 110b supporting the UE-ID based subgrouping, it would be appreciated that in some example embodiments, the base station 120 may broadcast the remapping indication for the network assigned subgroups and the remapping indication for the UE-ID based subgroups together to UEs served by the base station 120. The UEs can remap its own network assigned or UE-ID based subgroup to the L1 subgroup according to the received remapping indication.

The core network 103 or the RAN 102 may initiate a paging procedure to page a UE in the tracking area. In some example embodiments, the base station 120 may receive a paging notification for a UE from the AMF 130 or from another base station at an operation 226. The paging notification may include a UE ID to identify the UE to be paged and an indication of UE capability to support paging subgrouping. For example, if the UE to be paged supports network assignment based subgrouping, the UE capability indication may include a network assigned subgroup ID of the UE. Alternatively, the UE capability indication may indicate that the UE to be paged supports UE-ID based paging subgrouping or it is a legacy UE that does not support paging subgrouping.

If the paging notification received at the operation 226 includes the network assigned subgroup ID of the UE to be paged, the base station 120 may remap at an operation 228 the network assigned subgroup ID to a L1 subgroup based on the remapping relationship between the network assigned subgroups and the L1 subgroups determined at the operation 216. If the paging notification includes the indication of the UE to be paged supporting the UE-ID based subgrouping, at the operation 228 the base station 120 may determine a UE-ID based subgroup for the UE to be paged based on the UE ID of the UE to be paged, and remap the UE-ID based subgroup to a L1 subgroup based on the remapping relationship between the UE-ID based subgroups and the L1 subgroups determined at the operation 216. If the paging notification includes the indication that the UE to be paged is a legacy UE which does not support paging subgrouping, the operation 228 may be omitted at the base station 120.

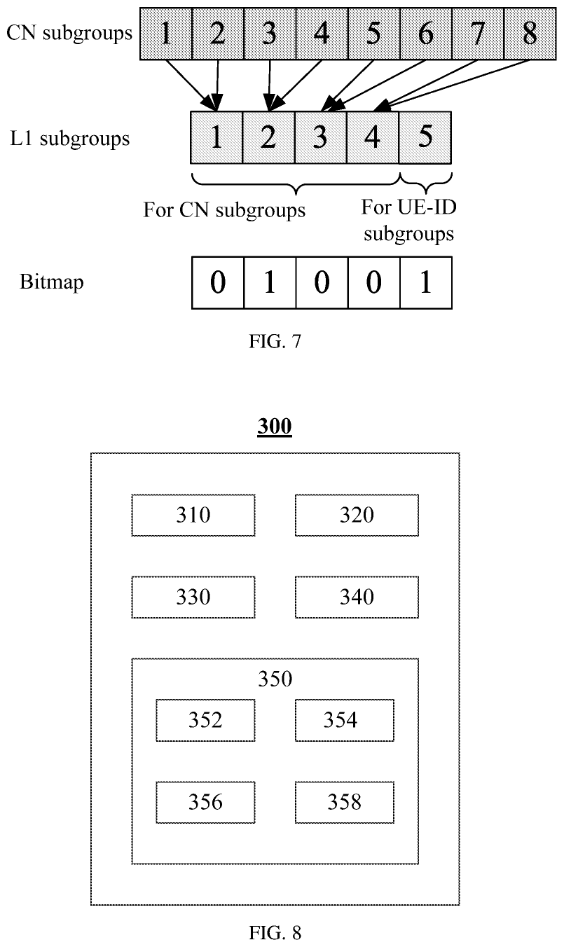

Then the base station 120 may page the UE using the remapped L1 subgroup ID. If the base station 120 has a split architecture including a centralized unit (CU) and a distributed unit (DU), the CU Control Plane (CU-CP) would send a request for PEI transmission including the L1 subgroup ID of each UE to be paged to the DU. At an operation 230, the base station 120 may transmit a paging early indication (PEI) including a L1 paging subgroup indication to the UEs served by the base station. In some example embodiments, the PEI may be carried in a downlink control information (DCI) information element transmitted on the PDCCH channel. The L1 paging subgroup indication may comprise a bitmap to indicate one or more subgroups to be paged, an example of which is shown in FIG. 7. Referring to FIG. 7, it is assumed that the network assigned paging subgroups #1-#8 are evenly remapped to the L1 paging subgroups #1-#4, and the UE-ID based paging subgroups are remapped to the last L1 paging subgroup #5. Furthermore, it is assumed that the base station 120 receives a paging notification including a UE ID and a network assigned subgroup ID #3 of the UE 110a, and a UE ID and an indication of supporting UE-ID based subgrouping for the UE 110b. The base station 120 may set the bit #2 and the last bit #5 in the bitmap to “true” and send the bitmap in the PEI to the UEs served by the base station 120.

In some example embodiments, the PEI may be based on a sequence, e.g., the secondary synchronization signal, instead of the DCI information element of the PDCCH-based PEI. A sequence may correspond to one or more L1 subgroups, and thus it corresponds to a combination of one or more of the L1 bits of the PDCCH-based PEI approach. For example, a cell may use (configure) a certain number of sequences including a sequence per L1 subgroup (where each sequence addresses only the corresponding L1 subgroup), and potentially additional sequences addressing more than one L1 subgroups (including combinations of 2, 3, and so forth subgroups). For example, if the L1 subgroup indication has to indicate 5 subgroups, there are 5 sequences #1-#5 corresponding to the L1 subgroups #1-#5, respectively, and in addition there may be 10 sequences #6-#15 corresponding to combinations of any two of the L1 subgroups, and further 10 sequences #16-#25 corresponding to combinations of any three of the L1 subgroups, and so forth. There will be 31 sequences corresponding to any combination of one or more of the 5 L1 subgroups. There may also be an additional sequence indicating that the PEI is directed to all UEs, not to a specific subgroup. In the example shown in FIG. 7, the base station 120 may select a sequence corresponding to a combination of the L1 bit #2 and #5 to page the UEs 110a and 110b. When using sequence-based PEI, the base station 120 would determine the remapping between the network assigned subgroup ID to one or more sequences.

The UEs 110a and 110b would monitor the PEI. When the UE 110a determines that the PEI indicates the L1 subgroup #2 corresponding to the network assigned subgroup #3 of the UE 110a, the UE 110b may wake up to receive and decode a paging message at an operation 232. Similarly, when the UE 110b determines that the PEI indicates the L1 subgroup #5 corresponding to the UE-ID based subgroup of the UE 110b, the UE 110b may wake up to receive and decode the paging message at the operation 232. In the example shown in FIG. 7, UEs in the network assigned subgroup #4 and UEs in UE-ID based subgroups other than the UE-ID based subgroup of the UE 110b would also be triggered by the PEI to receive and decode the paging message, but UEs in the network assigned subgroups #1-#2, #5-#8 would not be trigged. In this regard, the PEI with paging subgrouping can reduce the false paging alarms and save UE power for monitoring the paging message.

FIG. 8 is a schematic functional diagram illustrating an apparatus 300 in accordance with an example embodiment. The apparatus 300 may be implemented at a base station e.g. the base station 120 discussed above with a plurality of means, modules and/or elements to carry out the operations and functions relating to the base station 120 as discussed above. The means, modules and/or elements may be implemented in various manners including for example software, hardware, firmware or any combination thereof to perform the operations and functions.

Referring to FIG. 8, the apparatus 300 may include a first means 310 for determining for a cell a first number of Layer 1 (L1) paging subgroups for user equipment (UE) devices supporting a first paging subgrouping scheme and a second number of L1 paging subgroups for UE devices supporting a second paging subgrouping scheme. In some example embodiments, a non-limiting example of the first paging subgrouping scheme may comprise a network assignment based paging subgrouping, and a non-limiting example of the second paging subgrouping scheme may comprise a UE identity (UE-ID) based paging subgrouping. In some example embodiments, the determined L1 paging subgroups for UE devices supporting network assignment based paging subgrouping and the determined L1 paging subgroups for UE devices supporting UE-ID based paging subgrouping may be separate subgroups. In some example embodiments, one or more of the L1 paging subgroups for UE devices supporting UE-ID based paging subgrouping may overlap with one or more of the L1 subgroups for UE devices supporting network assignment based paging subgrouping.

The first number and the second number may be determined based on statistics information of UE devices supporting network assignment based paging subgrouping and/or UE devices supporting UE-ID based paging subgrouping. The statistics information may be available at the base station or received from a network function device in a core network, a network operation and maintenance system, or another base station. In some example embodiments, the statistics information may comprise a percentage of UE devices supporting network assignment based paging subgrouping and/or a percentage of UE devices supporting UE-ID based paging subgrouping in an aggregation of the UE devices supporting network assignment based paging subgrouping and the UE devices supporting UE-ID based paging subgrouping in a cell, a tracking area, or a registration area.

The apparatus 300 may further include a second means 320 for remapping a third number of first scheme (network assigned) paging subgroups at least to the first number of L1 paging subgroups when the first number is smaller than the third number. The third number of network assigned paging subgroups may be equal to a fixed predefined value for the network or equal to an integer value obtained by multiplying the fixed predefined value and the percentage of UE devices supporting network assignment based paging subgrouping.

In some example embodiments, the third number of network assigned paging subgroups may be remapped at least to the first number of L1 paging subgroups for UE devices supporting network assignment based paging subgrouping according to predefined or standardized remapping rules. In some other example embodiments, the third number of network assigned paging subgroups may be remapped at least to the first number of L1 paging subgroups according to remapping rules determined at the second means 320. The second means 320 may be configured to determine the remapping rules based on information of the network assigned paging subgroups received from a network function device in a core network. The information of the network assigned paging subgroups received from the network function device may include at least one of an estimated number of UE devices per network assigned paging subgroup or an average paging probability per network assigned paging subgroup.

With continuous reference to FIG. 8, the apparatus 300 may further include a third means 330 for indicating the remapping relationship between the network assigned paging subgroups and the L1 paging subgroups explicitly or implicitly to UE devices served by the base station. In some example embodiments, the third means 330 may be configured to provide subgrouping information for remapping to the UE devices served by the base station when the remapping between the network assigned paging subgroups and the L1 paging subgroups is determined according to predefined or standardized remapping rules. The UE devices may derive the remapping relationship between the network assigned paging subgroups and the L1 paging subgroups from the received subgrouping information for remapping. The subgrouping information for remapping may comprise one or more of information about cell support to network assignment based paging subgrouping or UE-ID based paging subgrouping, a number of L1 paging subgroups assigned to the network assigned paging subgroups or the UE-ID based paging subgroups, and/or a total number of available L1 subgroups. In some example embodiments, the third means 330 may be configured to provide an explicit association of one or more network assigned paging subgroups to one or more L1 paging subgroups.

In some example embodiments, the third means 330 may also be configured to provide an indication of one or more L1 paging subgroups associated with one or more UE-ID based paging subgroups to the UE devices served by the base station.

The apparatus 300 may further include a fourth means 340 for receiving a paging notification for a UE device including an indication of UE capability to support paging subgrouping from another base station or a network function device in a core network, and a fifth means 350 for paging the UE device based on the UE capability. The indication of UE capability to support paging subgrouping may include at least one of a network assigned subgroup ID indicating that the UE device supports network assignment based paging subgrouping, or an indication of supporting UE-ID based paging subgrouping.

The fifth means 350 may include a first sub-means 352, a second sub-means 354, a third sub-means 356 and a fourth sub-means 358. The first sub-means 352 may be configured to remap the network paging subgroup ID assigned to the UE device and received in the paging notification to one of the L1 paging subgroups based on the remapping relationship between the network assigned paging subgroups and the L1 paging subgroups. The second sub-means 354 may be configured to determine one of the L1 paging subgroups corresponding to a UE-ID based paging subgroup of the UE device at least when the paging notification includes the indication of supporting UE-ID based paging subgrouping. The third sub-means 356 may be configured to transmit a paging early indication (PEI) including an indication of the remapped/determined L1 paging subgroup, and the fourth sub-means 358 may be configured to transmit a paging message.

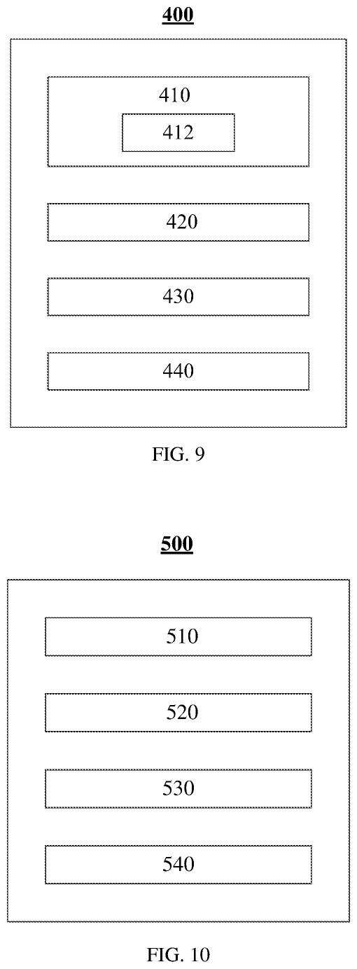

FIG. 9 is a schematic functional diagram illustrating an apparatus 400 in accordance with an example embodiment. The apparatus 400 may be implemented at a UE device e.g. the UE device 110a discussed above with a plurality of means, modules and/or elements to carry out the operations and functions relating to the UE device 110a as discussed above. The UE device 110a can support network assignment based paging subgrouping. The means, modules and/or elements may be implemented in various manners including for example software, hardware, firmware or any combination thereof to perform the operations and functions relating to the UE device 110a.

Referring to FIG. 9, the apparatus 400 may include a first means 410 for receiving from a base station an explicit or implicit indication of remapping between one or more paging subgroups of the first scheme (referred to as first scheme paging subgroups) and one or more L1 paging subgroups. The explicit indication of remapping may comprise an association of the network assigned paging subgroup of the UE device to a L1 paging subgroup. The implicit indication of remapping may comprise subgrouping information received from the base station, and the subgrouping information may include at least one of information about cell support to network assignment based paging subgrouping and/or UE-ID based paging subgrouping, a number of L1 paging subgroups assigned to the network assigned paging subgroups and/or the UE-ID based paging subgroups, or a total number of available L1 subgroups. In some example embodiments, the first means 410 may further comprise a sub-means 412 for deriving the remapping between the network assigned paging subgroup of the UE device and an L1 paging subgroup from the subgrouping information and predefined or standardized rules.

The apparatus 400 may further include a second means 420 for remapping a first scheme paging subgroup of the UE device to a L1 paging subgroup based on the received indication of remapping. A non-limiting example of the first scheme paging subgroups may comprise network assigned paging subgroups. The apparatus 400 may further include a third means 430 for monitoring for a paging early indication (PEI) from the base station including an indication of the remapped L1 paging subgroup, and a fourth means 440 for receiving a paging message from the base station based on the PEI.

FIG. 10 is a schematic functional diagram illustrating an apparatus 500 in accordance with an example embodiment. The apparatus 500 may be implemented at a UE device e.g. the UE device 110b discussed above with a plurality of means, modules and/or elements to carry out the operations and functions relating to the UE device 110b as discussed above. The UE device 110b can support UE-ID based paging subgrouping. The means, modules and/or elements may be implemented in various manners including for example software, hardware, firmware or any combination thereof to perform the operations and functions relating to the UE device 110b.

Referring to FIG. 10, the apparatus 500 may include a first means 510, a second means 520, a third means 530 and a fourth means 540. The first means 510 may be configured to receive from a base station an indication of remapping between one or more second scheme paging subgroups and one or more L1 paging subgroups. A non-limiting example of the second scheme paging subgroups may comprise UE identity (UE-ID) based paging subgroups. The second means 520 may be configured to remap a second scheme (UE-ID based) paging subgroup of the UE device to a L1 paging subgroup based on the received indication of remapping. The third means 530 may be configured to monitor for a paging early indication (PEI) from the base station including an indication of the remapped L1 paging subgroup, and the fourth means 540 may be configured to receive a paging message from the base station based on the PEI.

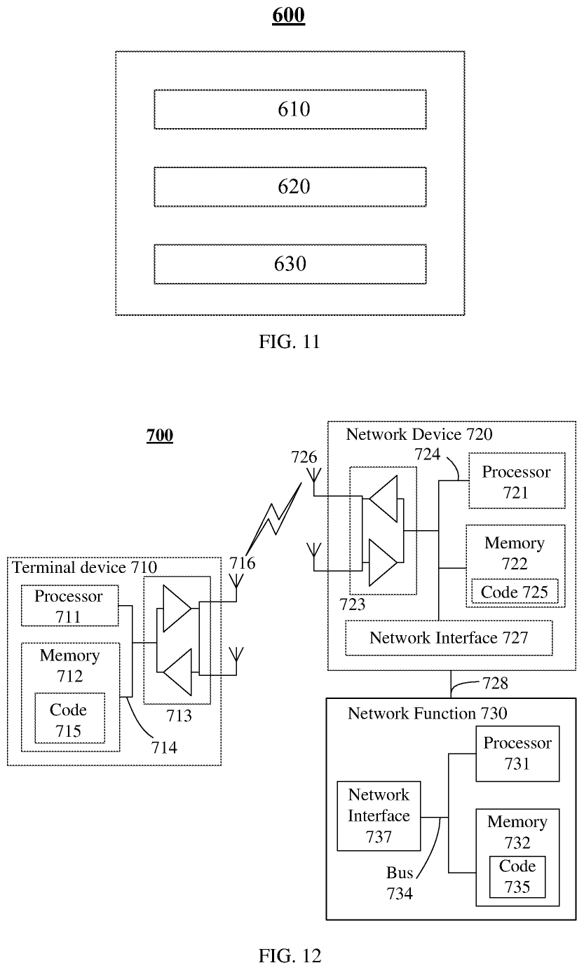

FIG. 11 is a schematic functional diagram illustrating an apparatus 600 in accordance with an example embodiment. The apparatus 600 may be implemented at a network function device in a core network e.g. the AMF 130 discussed above with a plurality of means, modules and/or elements to carry out the operations and functions relating to the AMF 130 as discussed above. The means, modules and/or elements may be implemented in various manners including for example software, hardware, firmware or any combination thereof to perform the operations and functions.

Referring to FIG. 11, the apparatus 600 may include a first means 610 for providing to a base station at least one of (i) statistics information of user equipment (UE) devices supporting a first paging subgrouping scheme and/or UE devices supporting a second paging subgrouping scheme or (ii) first scheme paging subgroup information comprising at least one of an estimated number of UE devices per first scheme paging subgroup and/or an average paging probability per first scheme paging subgroup. A non-limiting example of the first paging subgrouping scheme may comprise network assignment based paging subgrouping, and a non-limiting example of the second paging subgrouping scheme may comprise UE identity (UE-ID) based paging subgrouping. The statistics information may comprise a percentage of UE devices supporting network assignment based paging subgrouping and/or a percentage of UE devices supporting UE-ID based paging subgrouping in an aggregation of the UE devices supporting network assignment based paging subgrouping and the UE devices supporting UE-ID based paging subgrouping in a cell, a tracking area, or a registration area.

The apparatus 600 may further include a second means 620 for determining network assigned paging subgroups based on the statistics information of UE devices supporting UE-ID based paging subgrouping and/or UE devices supporting network assignment based paging subgrouping.

The apparatus 600 may further include a third means 630 for transmitting a paging notification for a UE device to the base station. The paging notification may include an indication of UE capability to support paging subgrouping. The indication of UE capability may comprise at least one of a network assigned paging subgroup ID indicating that the UE device supports network assignment based paging subgrouping, or an indication of supporting UE-ID based paging subgrouping.

FIG. 12 illustrates a structural block diagram of a communication system 700 in which example embodiments of the present disclosure may be implemented. As shown in FIG. 12, the communication system 700 may comprise a terminal device 710 which may be implemented as the UE 110 discussed above, a network device 720 which may be implemented as the base station 120 discussed above, and a network function device 730 which may be implemented as the AMF 130 discussed above.

Referring to FIG. 12, the terminal device 710 may comprise one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The terminal device 710 may wirelessly communicate with the network device 720 through the one or more antennas 716. The one or more memories 712 may include computer program code 715. The one or more memories 712 and the computer program code 715 may be configured to, when executed by the one or more processors 711, cause the terminal device 710 to perform processes and steps relating to the UE 110 as described above.

The network device 720 may comprise one or more processors 721, one or more memories 722, one or more transceivers 723 and one or more network interfaces 727 interconnected through one or more buses 724. The one or more buses 724 may be address, data, or control buses, and may include any interconnection mechanism such as a series of lines on a motherboard or integrated circuit, fiber, optics or other optical communication equipment, and the like. Each of the one or more transceivers 723 may comprise a receiver and a transmitter, which are connected to one or more antennas 726. The network device 720 may wirelessly communicate with the terminal device 710 through the one or more antennas 726. The one or more network interfaces 727 may provide wired or wireless communication links through which the network device 720 may communicate with other network devices, entities, elements or functions. The one or more memories 722 may include computer program code 725. The network device 720 may communicate with the network function 730 via backhaul connections 728. The one or more memories 722 and the computer program code 725 may be configured to, when executed by the one or more processors 721, cause the network device 720 to perform processes and steps relating to the base station 120 as described above.

The network function device 730 may comprise one or more processors 731, one or more memories 732, and one or more network interfaces 737 interconnected through one or more buses 734. The one or more buses 734 may be address, data, or control buses, and may include any interconnection mechanism such as a series of lines on a motherboard or integrated circuit, fiber, optics or other optical communication equipment, and the like. The network function device 730 may operate to carry out one or more network functions in the core network and wired or wirelessly communicate with the network device 720 through one or more links. The one or more network interfaces 737 may provide wired or wireless communication links through which the network function device 730 may communicate with other network devices, entities, elements or functions. The one or more memories 732 may include computer program code 735. The one or more memories 732 and the computer program code 735 may be configured to, when executed by the one or more processors 731, cause the network function device 730 to perform processes and steps relating to the AMF 130 as described above.

The one or more processors 711, 721 and 731 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711, 721 and 731 may be configured to control other elements of the UE/network device/network element and operate in cooperation with them to implement the procedures discussed above.

The one or more memories 712, 722 and 732 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 712, 722 and 732 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1-62. (canceled)

63. A user equipment (UE) device comprising:
at least one processor; and
at least one memory including computer program code, the at least one memory and the computer program code being configured to, with the at least one processor, cause the UE device to:
receive from a base station an explicit or implicit indication of remapping between one or more first scheme paging subgroups and one or more L1 paging subgroups;
remap a first scheme paging subgroup of the UE device to a L1 paging subgroup based on the received indication of remapping;
monitor for a paging early indication (PEI) from the base station including an indication of the remapped L1 paging subgroup; and
receive a paging message from the base station based on the PEI.

64. The UE device of claim 63 wherein the first scheme paging subgroups comprise network assigned paging subgroups.

65. The UE device of claim 64 wherein the explicit indication of remapping between one or more network assigned paging subgroups and one or more L1 paging subgroups comprises an association of the network assigned paging subgroup of the UE device to a L1 paging subgroup.

66. The UE device of claim 64 wherein receiving an implicit indication of remapping between one or more network assigned paging subgroups and one or more L1 paging subgroups comprises:
receiving subgrouping information comprising at least one of information about cell support to network assignment based paging subgrouping and/or UE-ID based paging subgrouping, a number of L1 paging subgroups assigned to the network assigned paging subgroups and/or the UE-ID based paging subgroups, or a total number of available L1 subgroups; and
deriving the remapping between the network assigned paging subgroup of the UE device and an L1 paging subgroup from the subgrouping information and predefined or standardized rules.

67. A network function device in a core network, comprising:
at least one processor; and
at least one memory including computer program code, the at least one memory and the computer program code being configured to, with the at least one processor, cause the network function device to:
provide to a base station at least one of (i) statistics information of user equipment (UE) devices supporting a first paging subgrouping scheme and/or UE devices supporting a second paging subgrouping scheme or (ii) first scheme paging subgroup information comprising at least one of an estimated number of UE devices per first scheme paging subgroup and/or an average paging probability per first scheme paging subgroup; and
transmit a paging notification for a UE device to the base station, the paging notification including an indication of UE capability to support paging subgrouping.

68. The network function device of claim 67 wherein the first paging subgrouping scheme comprises network assignment based paging subgrouping, and the second paging subgrouping scheme comprises UE identity (UE-ID) based paging subgrouping.

69. The network function device of claim 68 wherein the statistics information comprises a percentage of UE devices supporting network assignment based paging subgrouping and/or a percentage of UE devices supporting UE-ID based paging subgrouping in an aggregation of the UE devices supporting network assignment based paging subgrouping and the UE devices supporting UE-ID based paging subgrouping in a cell, a tracking area, or a registration area.

70. The network function device of claim 68 wherein the indication of UE capability to support paging subgrouping comprises at least one of a network assigned paging subgroup ID indicating that the UE device supports network assignment based paging subgrouping, or an indication of supporting UE-ID based paging subgrouping.

71. The network function device of claim 68 wherein the at least one memory and the computer program code are further configured to, with the at least one processor, cause the network function device to:
determine network assigned paging subgroups based on the statistics information of UE devices supporting UE-ID based paging subgrouping and/or UE devices supporting network assignment based paging subgrouping.

72. A method implemented at a user equipment (UE) device comprising:
receiving from a base station an explicit or implicit indication of remapping between one or more first scheme paging subgroups and one or more L1 paging subgroups;
remapping a first scheme paging subgroup of the UE device to a L1 paging subgroup based on the received indication of remapping;
monitoring for a paging early indication (PEI) from the base station including an indication of the remapped L1 paging subgroup; and
receiving a paging message from the base station based on the PEI.

73. The method of claim 72 wherein the first scheme paging subgroups comprise network assigned paging subgroups.

74. The method of claim 73 wherein the explicit indication of remapping between one or more network assigned paging subgroups and one or more L1 paging subgroups comprises an association of the network assigned paging subgroup of the UE device to a L1 paging subgroup.

75. The method of claim 73 wherein receiving an implicit indication of remapping between one or more network assigned paging subgroups and one or more L1 paging subgroups comprises:
receiving subgrouping information comprising at least one of information about cell support to network assignment based paging subgrouping and/or UE-ID based paging subgrouping, a number of L1 paging subgroups assigned to the network assigned paging subgroups and/or the UE-ID based paging subgroups, or a total number of available L1 subgroups; and
deriving the remapping between the network assigned paging subgroup of the UE device and an L1 paging subgroup from the subgrouping information and predefined or standardized rules.
